(19) United States
(12) Patent Application Publication
(10) Pub. No.: US 2020/0102509 A1
(43) Pub. Date: Apr. 2, 2020

(54) PROCESS USING MEMBRANES TO SEPARATE ALKANE ISOMERS USED IN STEAM CRACKING TO MAKE OLEFINS

(71) Applicant: Chevron U.S.A. Inc., San Ramon, CA (US)

(72) Inventors: Nitesh Bhuwania, Richmond, CA (US); Viorel Duma, Hercules, CA (US); Daniel Chinn, Danville, CA (US); Theodorus Ludovicus Michael Maesen, Lafayette, CA (US)

(21) Appl. No.: 16/585,069

(22) Filed: Sep. 27, 2019

Related U.S. Application Data
(60) Provisional application No. 62/737,302, filed on Sep. 27, 2018.

(51) Int. Cl. C10G 55/04; C10G 69/10; B01D 61/02

(52) U.S. Cl. CPC C10G 55/04; C10G 69/10; C10G 2300/4056; C10G 2300/1074; C10G 2300/1055; B01D 61/027

(57) ABSTRACT

Provided herein is a process for separating alkane isomers from a hydrocarbon mixture in an integrated refining unit, comprising: passing the hydrocarbon mixture through a normal alkane-selective membrane in a single stage to produce a normal alkane-enriched stream and a membrane reject stream; and feeding the normal alkane-enriched stream to a steam cracker to produce olefins; wherein the hydrocarbon mixture comprises n-paraffins and at least two of isoparaffins, cycloparaffins, and aromatics.

### TECHNICAL FIELD

This application is directed to processes for preparing a feed stream enriched in normal paraffins using membranes to produce a preferred feed for steam cracking.

### BACKGROUND

It is desired to have improved processes using membranes for separating normal alkanes from other alkane isomers in an integrated refining unit that includes a steam cracker to produce olefins. In the petrochemical industry, olefins, especially light olefins such as ethene, propene, and butene, are important precursors for downstream processes. Normal alkanes are preferred feeds to steam crackers as they provide a higher yield of light olefins compared to iso-alkanes, cyclo-alkanes, and aromatics.

Many hydrocarbon mixtures are readily available that contain mixtures of normal alkanes with other alkanes and other hydrocarbons. Many hydrocarbon mixtures can comprise a wide range of carbon numbers.

Separation of normal alkanes from hydrocarbon mixtures have been done using adsorption processes using materials like molecular sieves. Earlier processes to separate normal alkanes from other alkane isomers using adsorption are expensive and energy intensive. Earlier processes have also tended to be more efficient for hydrocarbon mixtures with a narrow range of carbon numbers and/or low molecular weight.

### SUMMARY

Provided herein is a process for separating alkane isomers from a hydrocarbon mixture in an integrated refining unit, comprising:
a. passing the hydrocarbon mixture through a normal alkane-selective membrane in a single stage to produce a normal alkane-enriched stream and a membrane reject stream;
b. feeding the normal alkane-enriched stream to a steam cracker to produce olefins;
   wherein the hydrocarbon mixture comprises n-paraffins and at least two of isoparaffins, cycloparaffins, and aromatics.

Also provided is an integrated refining unit that performs the processes disclosed herein, comprising: the steam cracker; the normal alkane-selective membrane that is fluidly connected to the steam cracker; and a hydrocracker that has a first pipe, that receives the membrane reject stream from the normal alkane-selective membrane, and a second pipe that elutes a hydrocracked stream to the steam cracker.

The present invention may suitably comprise, consist of, or consist essentially of, the claims and embodiments, as described herein.

### BRIEF DESCRIPTION OF THE DRAWINGS

FIG. 1 is a schematic block flow diagram of a process using an organic solvent nanofiltration (OSN) membrane.

FIG. 2 is a schematic block flow diagram of a process using a pervaporation membrane.

FIG. 3 is a block flow diagram of one integrated process scheme using membrane separation and providing a normal alkane-enriched stream to a steam cracker.

FIG. 4 is a block flow diagram of an exemplary integrated process scheme using membrane separation and providing a normal alkane-enriched stream to a steam cracker and a membrane reject stream to a hydrocracker.

FIG. 5 is a block flow diagram of a previously used process to combine hydrocracking with steam cracking.

FIG. 6 is a block flow diagram of an integrated process scheme using intermediate membrane separations between a steam cracker and a full conversion hydrocracker.

### GLOSSARY

A “normal alkane-selective membrane” is a selective barrier that allows more normal alkanes to pass through but stops or limits other hydrocarbons from passing through.

A “normal alkane-enriched stream” is a hydrocarbon stream that has passed through a normal alkane-selective membrane.

A “membrane reject steam” is a portion of a hydrocarbon mixture that was limited from passing through a normal alkane-selective membrane.

A “steam cracker” is a process unit in a refinery in which a feedstock such as naphtha, liquefied petroleum gas (LPG), ethane, propane or butane is thermally cracked using steam in a bank of pyrolysis furnaces to produce lighter hydrocarbons.

“Hydrocracking” is a catalytic chemical process performed using a hydrocracker in petroleum refineries for converting the high-boiling constituent hydrocarbons in petroleum crude oils to more valuable lower-boiling products such as gasoline, kerosene, jet and diesel. Hydrocracking typically takes place in a hydrogen-rich atmosphere at elevated temperatures (260-425° C.) and pressures (35-200 bar). Hydrocracking converts the high-boiling, high molecular weight hydrocarbons into lower-boiling, lower molecular weight olefinic and aromatic hydrocarbons and then hydrogenates them. Any sulfur and nitrogen present in the hydrocracking feedstock are, to a large extent, also hydrogenated and form gaseous hydrogen sulfide (H₂S) and ammonia (NH₃) which are subsequently removed. The result is that the hydrocracked products are essentially free of sulfur and nitrogen impurities and consist of predominantly paraffinic hydrocarbons (n-paraffins and isoparaffins) and remaining cycloparaffins, or aromatics.

“Isomerization” refers to the chemical process by which a hydrocarbon molecule is transformed into any of its isomeric forms, i.e., forms with the same chemical composition but with different structure or configuration and, hence, generally with different physical and chemical properties. For example, isomerization can transform an n-paraffin into an isoparaffin or an isoparaffin into an n-paraffin and the transformation is controlled by the careful selection of an isomerization catalyst and isomerization process conditions in an isomerization reactor.

“Predominantly” in the context of this disclosure means from greater than 50 wt % to 99 wt %.

“Essentially free” in the context of this disclosure means from zero to less than 100 wppm.

“Essentially all” in the context of this disclosure means from greater than 90 wt % to 100 wt %.

“Pervaporation” is a processing method for the separation of mixtures of liquids by partial vaporization through a non-porous or porous membrane. It should be noted that the term “pervaporation” (a combination of words “permeation” and “evaporation”) was coined by P. A. Kober as early as in 1917.

“TBP” refers to the boiling point of a hydrocarbon mixture or product, as determined by ASTM D2887-18.

“Distillates” include the following products:

| | Typical Boiling Point Ranges, ° F. (° C.) | |
|---|---|---|
| Products | for North American Market | |
| Light Naphtha | C₅-180 | (C₅-82) |
| Heavy Naphtha | 180-300 | (82-149) |
| Jet | 300-380 | (149-193) |
| Kerosene | 380-530 | (193-277) |
| Diesel | 530-700 | (277-371) |
| Vacuum Gas Oil (VGO) | 700-1150 | (371-621) |

“Naphtha” in the context of this disclosure refers to petroleum naphtha that is an intermediate hydrocarbon liquid stream derived from the refining of crude oil. It can have a carbon number within the range from C5 to C12.
“Heavy hydrocarbons” in the context of this disclosure refers to distillates with boiling point ranges of diesel and/or VGO.
“Fuel oil” is a fraction obtained from petroleum distillation, either as a distillate or a residue. It is made of long hydrocarbon chains, particularly alkanes, cycloalkanes and aromatics.

A “full conversion hydrocracker” converts essentially all the VGO that is fed into the full conversion hydrocracker into products with a boiling point range below 371° C.

### DETAILED DESCRIPTION

The normal alkane-selective membrane can be any membrane that is compatible with the hydrocarbon mixture and produces a normal alkane-enriched stream and a membrane reject stream. In one embodiment, the normal alkane-enriched stream has more than at least double the wt % of the normal alkanes that were originally present in the hydrocarbon mixture. In one embodiment, a weight ratio of the normal alkanes in the normal alkane-enriched stream to the normal alkanes in the hydrocarbon mixture is from 2:1 to 100:1.

In one embodiment the normal alkane-selective membrane is an organic solvent nanofiltration (OSN) membrane. OSN membranes are generally described in https://pubs.acs.org/doi/pdfplus/10.1021/cr500006j. OSN membranes have been prepared from both polymeric and inorganic materials. OSN membranes operate under a molecular size cut-off regime. OSN membrane performance can be characterized by the membrane nominal molecular-weight-cut-off (MWCO), which is defined as the smallest solute molecular weight for which the membrane has 90% rejection (Reji (%)≥90). MWCO is measured by the method described by See Toh, Y.; Loh, X.; Li, K.; Bismarck, A.; Livingston, A. J., Membrane Sci. 2007, 291, 120.

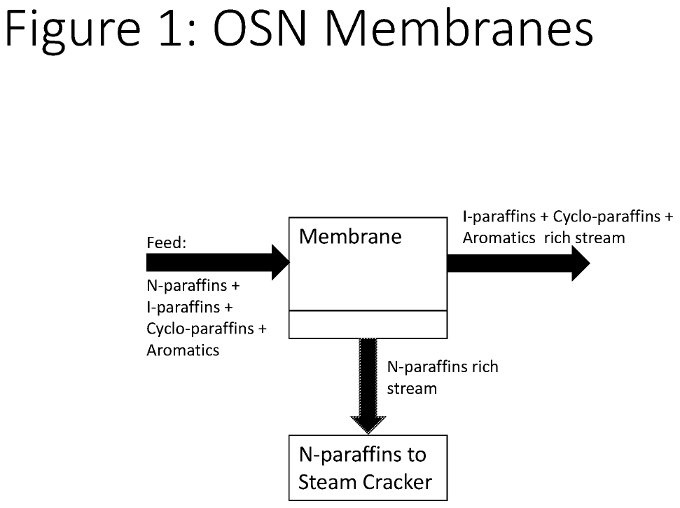

There are several commercial suppliers of OSN membranes, including Evonik-MET Ltd., Koch Membrane Systems, W.R. Grace & Co, PoroGen, AMS Technologies, and SolSep BV. In one embodiment, the OSN membrane is an integrally skinned asymmetric (ISA) membrane. One example of a suitable OSN membrane is an ISA OSN membrane based on cross-linked polyimide prepared by phase inversion. In one embodiment the OSN membrane is an integrally skinned OSN membrane based on P84 polyimide. In one embodiment, the OSN membrane is a rubber-coated polyimide membrane. In one embodiment the OSN membrane has a MWCO in the range from 120 to 1500 g/mol. In one embodiment, the OSN membrane can be in a flat sheet or a spiral-wound or a hollow fiber element. FIG. 1 demonstrates one embodiment of the process of this disclosure using an OSN membrane.

In one embodiment, such as when using an OSN membrane, the hydrocarbon mixture remains in a liquid phase during the step of passing the hydrocarbon mixture through the normal alkane-selective membrane in the single stage to produce the normal alkane-enriched stream and the membrane reject stream.

In one embodiment, the normal alkane-selective membrane is a pervaporation membrane. Pervaporation is a dense membrane process which can be used for selective separation of hydrocarbons based on selective sorption and diffusion of one of the components through the membrane. It differs from the other membrane processes in the fact that the diffusing species (e.g., n-paraffins) can undergo a phase change as they diffuse through the membrane. The pervaporation membrane can act as a barrier between the hydrocarbon mixture in the liquid phase and the permeate in the vapor phase. The driving force responsible for transport across the pervaporation membrane is a chemical potential/activity gradient across the pervaporation membrane which can be generated by preheating the hydrocarbon mixture and vaporizing the permeate. In one embodiment, the permeate from the pervaporation membrane is a gas, the hydrocarbon mixture is a liquid, and the retentate is a liquid.

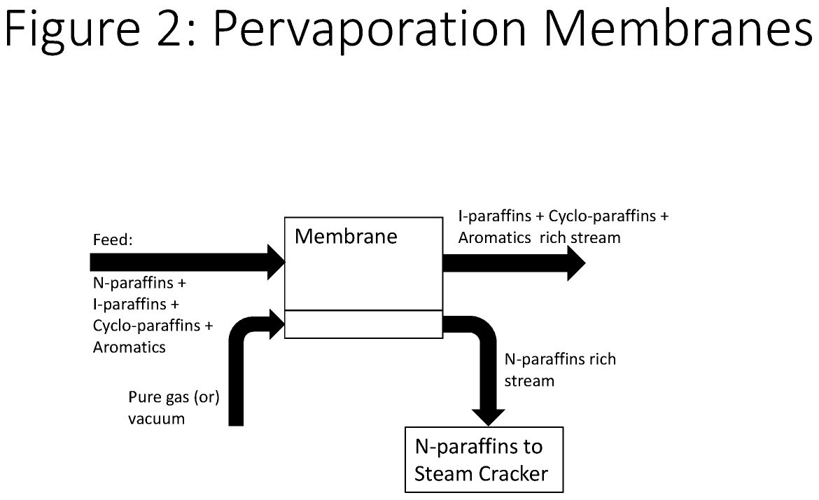

In one embodiment using a pervaporation membrane, the hydrocarbon mixture is pre-heated prior to passing the hydrocarbon mixture through the normal alkane-selective membrane. In one embodiment using a pervaporation membrane, a purge (pure gas) or a vacuum is applied on a permeate side of the pervaporation membrane to drive smaller molecules to permeate through the pervaporation membrane. Pervaporation membranes are commercially available from a number of suppliers, including Compact Membrane Systems, Porous Materials Inc., ECN Biomass & Energy Efficiency, Pervatech, and DeltaMem AG. FIG. 2 demonstrates one embodiment of this disclosure using a pervaporation membrane.

In one embodiment, the pervaporation membrane comprises a polymeric ionomer, wherein the polymeric ionomer has a highly fluorinated backbone and recurring pendant groups. Examples of these types of pervaporation membranes are taught in US20180229186A1. The hydrocarbon mixture comprises n-paraffins, and at least two of isoparaffins, cycloparaffins, and aromatics. In one embodiment, the hydrocarbon mixture comprises n-paraffins, isoparaffins, cycloparaffins, and aromatics. The membrane reject has a reduced amount of the n-paraffins that were originally present in the hydrocarbon mixture. In one embodiment, the membrane reject stream comprises the at least two of the isoparaffins, the cycloparaffins, and the aromatics. In one embodiment, the membrane reject stream comprises the isoparaffins, the cycloparaffins, and the aromatics. In one embodiment, the membrane reject stream comprises at least 70 wt %, at least 80 wt %, or at least 90 wt % of the isoparaffins, the cycloparaffins, and the aromatics that were originally present in the hydrocarbon mixture. Depending on the composition of the membrane reject stream, it can be processed or used in several different ways. In one embodiment, the membrane reject stream can be used directly as a fuel.

In one embodiment, such as when using a pervaporation membrane, the hydrocarbon mixture is pre-heated prior to the step of passing the hydrocarbon mixture through the normal alkane-selective membrane in the single stage to produce the normal alkane-enriched stream and the membrane reject stream; and a purge gas or a vacuum is applied on a permeate side of the normal alkane-selective membrane.

The hydrocarbon mixture can have a carbon number of C8⁺. In one embodiment, the hydrocarbon mixture can comprise hydrocarbons having a diesel boiling point range and a vacuum gas oil (VGO) boiling point range. In one embodiment the hydrocarbon mixture comprises a naphtha, a kerosene, a diesel, or a mixture thereof.

The steam cracker performs a petrochemical process in which saturated hydrocarbons in a feed to the steam cracker are broken down into smaller, often unsaturated, hydrocarbons. It is the principal industrial method for producing lighter alkenes (olefins), including ethylene and propylene. In steam cracking, a gaseous or liquid hydrocarbon feed is diluted with steam and then briefly heated in a furnace, without the presence of oxygen. Typically, the steam cracking reaction temperature is very hot (around 850° C.) but the reaction is only allowed to take place very briefly. In modern steam crackers, the residence time can be reduced to milliseconds (resulting in gas velocities reaching speeds beyond the speed of sound) in order to improve the yield of desired products.

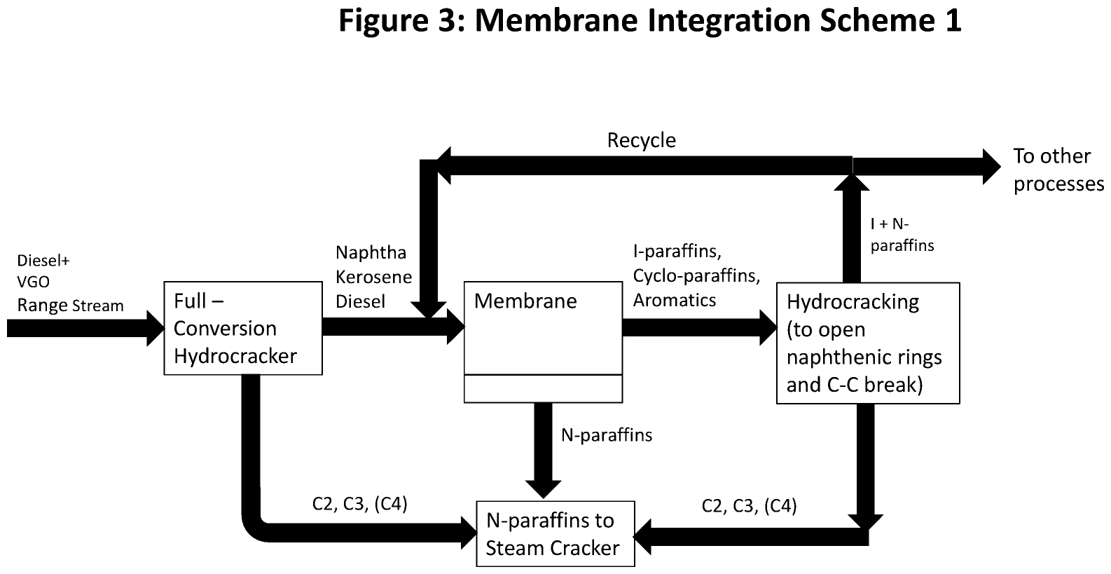

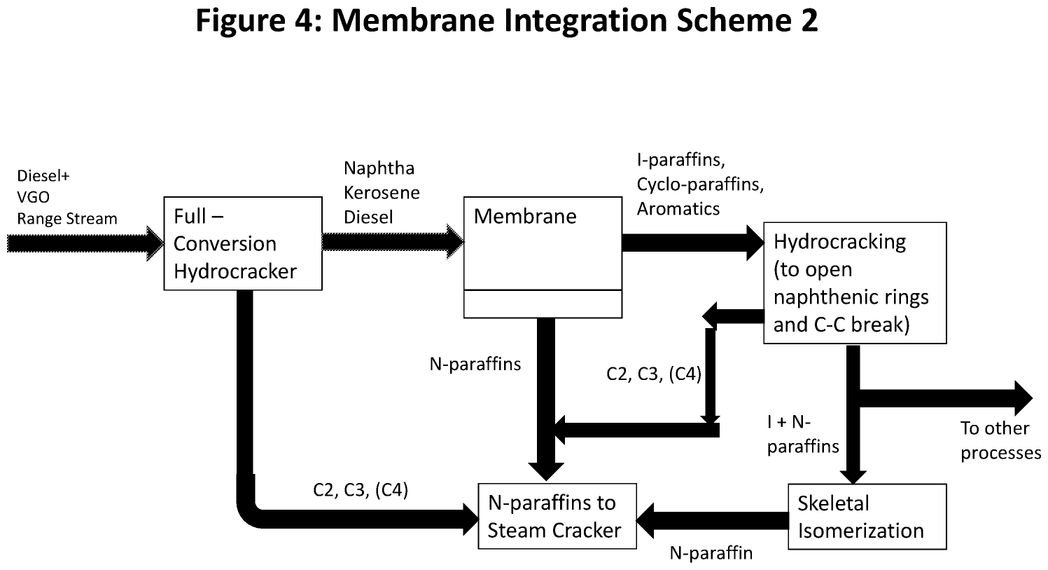

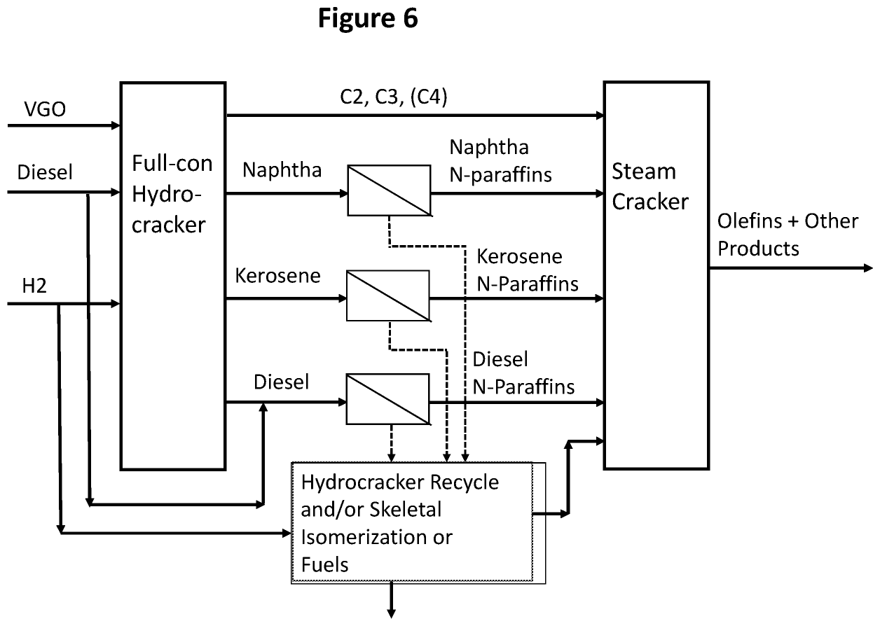

After the steam cracking temperature has been reached, the gas is quickly quenched to stop the reaction in a transfer line exchanger. The products produced in the reaction depend on the composition of the feed, on the hydrocarbon to steam ratio and on the cracking temperature and furnace residence time. In one embodiment, the process additionally comprises feeding the membrane reject stream to a hydrocracker. This embodiment is illustrated in FIGS. 3 and 4. Feeding the membrane reject stream to the hydrocracker can be used to open naphthenic rings and break carbon-carbon bonds in the membrane reject stream to improve this stream for further processing. Any hydrocracking catalyst that be used to open naphthenic rings, break carbon-carbon bonds, or both can be used in the hydrocracker. One example of a catalyst that can be used in the hydrocracker is mordenite. Alternatively, the process can comprise recycling the membrane reject stream to a full-conversion hydrocracker, as is an option shown in FIG. 6.

In one embodiment, the process additionally comprises recycling an amount of the isoparaffins and the n-paraffins from the hydrocracker to either the hydrocarbon mixture that is passed through the normal alkane-selective membrane (as shown in FIG. 3) or to the full-conversion hydrocracker. Recycling the amount of the isoparaffins and the n-paraffins from the hydrocracker further enriches the normal-alkane enriched stream that is fed to the steam cracker to produce olefins. The portion of the isoparaffins and the n-paraffins from the hydrocracker that is not recycled can be sent to other downstream processes.

In one embodiment, the process comprises feeding the membrane reject stream to a hydrocracker and additionally separating an effluent from the hydrocracker into a C2-C4 hydrocarbon fraction and a hydrocracked fraction that comprise the n-paraffins and the isoparaffins; feeding the C2-C4 hydrocarbon fraction to the steam cracker; and skeletally isomerizing at least a portion of the hydrocracked fraction to produce a second normal alkane-enriched stream that is fed to the steam cracker. This embodiment is illustrated in FIG. 4.

In one embodiment, the process additionally comprises feeding a stream of heavy hydrocarbons to a full-conversion hydrocracker that produces a low-boiling C2-C4 hydrocarbon fraction and at least one higher-boiling hydrocarbon fraction that is the hydrocarbon mixture that passes through the normal alkane-selective membrane; and feeding the normal alkane-enriched stream and the low-boiling C2-C4 hydrocarbon fraction to the steam cracker. This embodiment is illustrated in FIGS. 3 and 4.

In one embodiment, where a full-conversion hydrocracker is used, the at least one higher-boiling hydrocarbon fraction produced in the full-conversion hydrocracker is distilled into two or more intermediate streams and each of the two or more intermediate streams is separately passed through the normal alkane-selective membrane. Examples of these intermediate streams can include naphtha, light naphtha, heavy naphtha, jet, kerosene, and diesel, and mixtures thereof. In this embodiment, at least two (or even all) of the membrane reject streams produced from each of the two or more intermediate streams can be fed to the steam cracker. These embodiments are illustrated in FIG. 6.

In one embodiment, different normal alkane-selective membranes can be used for the different two or more intermediate streams, and the different normal alkane-selective membranes can be selected to optimize the separation of the n-paraffins into the normal alkane-enriched stream from each of the different normal alkane-selective membranes. For example, the two or more intermediate streams could comprise a naphtha stream, a kerosene stream and a diesel stream; and after separately passing the two or more intermediate streams through a first normal alkane-selective membrane that is selected for the naphtha stream, a second normal alkane-selective membrane that is selected for the kerosene stream, and a third normal alkane-selective membrane that is selected for the diesel stream; a naphtha n-paraffins stream is fed to the steam cracker, a kerosene n-paraffins stream is fed to the steam cracker, and a diesel n-paraffins stream is fed to the steam cracker. In another related embodiment, a first normal alkane-enriched stream from a first normal alkane-selective membrane, a second normal alkane-enriched stream from a second normal alkane-selective membrane, and a third normal alkane-enriched stream from a third normal alkane-selective membrane are fed to the steam cracker; a first membrane reject stream the first normal alkane-selective membrane, a second membrane reject stream from the second normal alkane-selective membrane, and a third membrane reject stream from the third normal alkane selective membrane are sent to an intermediate-range hydrocracker that elutes a hydrocracked intermediate stream that is fed to the steam cracker. This integrated scheme is shown in FIG. 6.

FIG. 6 is one processing scheme that can be used for combining hydrocracking with steam cracking. The hydrocracker product streams are distilled into fractions and each fraction is passed through a normal alkane-selective membrane in a single stage to produce normal alkane-enriched streams that are fed to the steam cracker. The membrane reject streams (normal-paraffin depleted) can be used or processed further. For example, the membrane reject streams may be useful as fuels, they may be recycled to the full conversion hydrocracker, or isomerized. The diesel stream that comes into the integrated refining unit can be converted entirely in the full conversion hydrocracker, converted in part in the full conversion hydrocracker, or fed entirely or in part to the normal alkane-selective membrane, as shown.

In one embodiment, the hydrocarbon mixture that is passed though the normal alkane-selective membrane is, in part or entirely, fed directly to the normal alkane-selective membrane without previously passing through a full conversion hydrocracker or another hydrocracker. Examples of hydrocarbon mixtures that could be fed directly to the normal alkane-selective membrane in this manner include light naphtha, heavy naphtha, naphtha, kerosene, jet, and diesel. These hydrocarbon mixtures could be obtained from other equipment in the same refinery that comprises the integrated refining unit or brought in from other sources.

One of the key benefits of the processes of this disclosure are significantly increased yields of olefins when using a steam cracker. Yields of olefins using the same steam cracker can be increased by greater than 5 wt %, such as from 10 to 50 wt %, or from 13 to 42 wt % compared to an alternative process without the passing of the hydrocarbon mixture through the normal alkane-selective membrane in the single stage, whereby the hydrocarbon mixture is passed directly to the steam cracker in the alternative process.

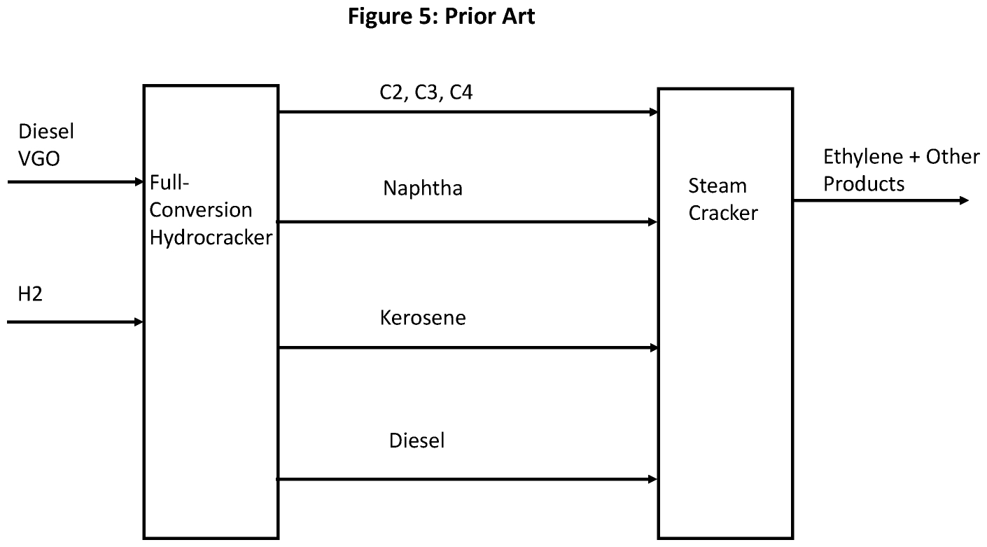

FIG. 5 shows a typical integrated refining unit comprising a full-conversion hydrocracker and a steam cracker, but without any inter-stage process to produce a normal alkane-enriched stream that is fed to the steam cracker. The full conversion hydrocracker converts larger hydrocarbon molecules into smaller molecules. Depending on the economics for hydrocracker product streams, some of these streams can be used as feedstocks to a steam cracker, e.g., C2-C4, naphtha, kerosene, and diesel. The normal alkane isomers in the hydrocracker product streams provide high yields to olefins in the steam cracker, however the other isomers that remain in the hydrocracker product streams (isoparaffins, cycloparaffins, and/or aromatics) provide lower yields to olefins and higher yields to less desired products like heavy aromatics, fuel oil, and pyrolysis oil. Light hydrocarbon feeds (such as ethane, LPG, or light naphthas) give product streams rich in the lighter alkenes, including ethylene, propylene, and butadiene. Heavier hydrocarbon (full range and heavy naphthas as well as other refinery products such as kerosene or diesel) feeds give some of these lighter alkenes, but also give other products rich in aromatic hydrocarbons and hydrocarbons suitable for inclusion in gasoline or fuel oil.

In one embodiment the yield of olefins, such as light C4⁻ olefins from a steam cracker is significantly increased, e.g., from greater than 5 wt % to 25 wt %, or to 30 wt %, using the processes of this disclosure. In one embodiment, a yield of total olefins can be increased by 10 wt % to 50 wt %. For example, the passing of the hydrocarbon mixture through the normal alkane-selective membrane can increase a yield of ethylene, propylene, or a mixture thereof in the steam cracker. Ethylene and propylene are important sources of industrial chemicals and polymer products. They can also be used as feeds to alkylation processes. Ethylene is used as a ripening stimulant.

In one embodiment, the process increases a yield of ethylene and/or propylene in the steam cracker and lowers the production of fuel oil by decreasing an amount of isoparaffins, cycloparaffins, and aromatics in the feed to the steam cracker. For example, the yield of ethylene and/or propylene can be increased by from greater than 5 wt % to 50 wt % (such as from 10 wt % to 50 wt %) and the production of fuel oil can be decreased by from greater than 5 wt % to 90 wt % (such as from 30 to 90 wt %).

In one embodiment, the process additionally comprises isomerizing at least a portion of the membrane reject stream. The isomerizing can be used to produce additional n-paraffins that can be fed to the steam cracker. One example of this embodiment is shown in FIG. 4, in which the portion of the membrane reject stream additionally passes through an intermediate-range hydrocracker before it is sent to the isomerization reactor. In another embodiment, the isomerizing can be used to transform n-paraffins into isoparaffins. Branched hydrocarbons are preferable to straight-chain hydrocarbons as ingredients in gasoline and other fuels because they burn more efficiently and have a higher-octane number. Skeletal isomerization can introduce branching into n-paraffins, by converting them to isoparaffins, to produce higher quality fuels.

Provided herein is a new use of a normal alkane-selective membrane to enrich a hydrocarbon mixture in n-paraffins in an integrated refining unit comprising a steam cracker.

The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

For the purposes of this specification and appended claims, unless otherwise indicated, all numbers expressing quantities, percentages or proportions, and other numerical values used in the specification and claims, are to be understood as being modified in all instances by the term “about.” Furthermore, all ranges disclosed herein are inclusive of the endpoints and are independently combinable. Whenever a numerical range with a lower limit and an upper limit are disclosed, any number falling within the range is also specifically disclosed. Unless otherwise specified, all percentages are in weight percent.

Any term, abbreviation or shorthand not defined is understood to have the ordinary meaning used by a person skilled in the art at the time the application is filed. The singular forms “a,” “an,” and “the,” include plural references unless expressly and unequivocally limited to one instance.

All the publications, patents and patent applications cited in this application are herein incorporated by reference in their entirety to the same extent as if the disclosure of each individual publication, patent application or patent was specifically and individually indicated to be incorporated by reference in its entirety.

This written description uses examples to disclose the invention, including the best mode, and also to enable any person skilled in the art to make and use the invention. Many modifications of the exemplary embodiments of the invention disclosed above will readily occur to those skilled in the art. Accordingly, the invention is to be construed as including all structure and methods that fall within the scope of the appended claims. Unless otherwise specified, the recitation of a genus of elements, materials or other components, from which an individual component or mixture of components can be selected, is intended to include all possible sub-generic combinations of the listed components and mixtures thereof.

The invention illustratively disclosed herein suitably may be practiced in the absence of any element which is not specifically disclosed herein.

It is claimed:

1. A process for separating alkane isomers from a hydrocarbon mixture in an integrated refining unit, comprising:
a. passing the hydrocarbon mixture through a normal alkane-selective membrane in a single stage to produce a normal alkane-enriched stream and a membrane reject stream; and
b. feeding the normal alkane-enriched stream to a steam cracker to produce olefins;
wherein the hydrocarbon mixture comprises n-paraffins and at least two of isoparaffins, cycloparaffins, and aromatics.

2. The process of claim 1, wherein the normal alkane-selective membrane is an organic solvent nanofiltration (OSN) membrane.

3. The process of claim 1, wherein the normal alkane-selective membrane is a pervaporation membrane.

4. The process of claim 1, wherein the membrane reject stream comprises the at least two of the isoparaffins, the cycloparaffins, and the aromatics.

5. The process of claim 1, wherein the hydrocarbon mixture comprises a naphtha, a kerosene, a diesel, or a mixture thereof.

6. The process of claim 1, additionally comprising feeding the membrane reject stream to a hydrocracker.

7. The process of claim 6, additionally comprising separating an effluent from the hydrocracker into a C2-C4 hydrocarbon fraction and a hydrocracked fraction that comprises the n-paraffins and the isoparaffins; feeding the C2-C4 hydrocarbon fraction to the steam cracker; and skeletally isomerizing at least a portion of the hydrocracked fraction to produce a second normal alkane-enriched stream that is fed to the steam cracker.

8. The process of claim 1, wherein the hydrocarbon mixture remains in a liquid phase during the passing step a).

9. The process of claim 1, wherein the hydrocarbon mixture is pre-heated prior to the passing step a) and a purge gas or a vacuum is applied on a permeate side of the normal alkane-selective membrane.

10. The process of claim 1, additionally comprising feeding a stream of heavy hydrocarbons to a full-conversion hydrocracker that produces a low-boiling C2-C4 hydrocarbon fraction and at least one higher-boiling hydrocarbon fraction that is the hydrocarbon mixture that passes through the normal alkane-selective membrane; and feeding the normal alkane-enriched stream and the low-boiling C2-C4 hydrocarbon fraction to the steam cracker.

11. The process of claim 10, wherein the at least one higher-boiling hydrocarbon fraction is distilled into two or more intermediate streams and each of the two or more intermediate streams is separately passed through the normal alkane-selective membrane that is selected for each of the two or more intermediate streams.

12. The process of claim 11, wherein the membrane reject stream produced from each of the two or more intermediate streams is fed to the steam cracker.

13. The process of claim 11, wherein the two or more intermediate streams comprise a naphtha stream, a kerosene stream and a diesel stream; and after separately passing the two or more intermediate streams through a first normal alkane-selective membrane that is selected for the naphtha stream, a second normal alkane-selective membrane that is selected for the kerosene stream, and a third normal alkane-selective membrane that is selected for the diesel stream; a naphtha n-paraffins stream is fed to the steam cracker, a kerosene n-paraffins stream is fed to the steam cracker, and a diesel n-paraffins stream is fed to the steam cracker.

14. The process of claim 11, wherein:
a first normal alkane-enriched stream from a first normal alkane-selective membrane, a second normal alkane-enriched stream from a second normal alkane-selective membrane, and a third normal alkane-enriched stream from a third normal alkane-selective membrane are fed to the steam cracker;
a first membrane reject stream from the first normal alkane-selective membrane, a second membrane reject stream from the second normal alkane-selective membrane, and a third membrane reject stream from the third normal alkane-selective membrane are sent to an intermediate-range hydrocracker that elutes a hydrocracked intermediate stream that is fed to the steam cracker.

15. The process of claim 10, additionally comprising recycling the membrane reject stream to the full-conversion hydrocracker.

16. The process of claim 1, wherein the passing of the hydrocarbon mixture through the normal alkane-selective membrane increases a yield of olefins in the steam cracker from 13 to 20 wt % compared to an alternative process without the passing step a) whereby the hydrocarbon mixture is passed directly to the steam cracker.

17. The process of claim 1, wherein the passing of the hydrocarbon mixture through the normal alkane-selective membrane increases a yield of ethylene, propylene, or a mixture thereof in the steam cracker.

18. The process of claim 1, additionally comprising isomerizing a portion of the membrane reject stream to produce additional n-paraffins that can be fed to the steam cracker.

19. The process of claim 6, additionally comprising recycling an amount of the isoparaffins and the n-paraffins from the hydrocracker to the hydrocarbon mixture that is passed through the normal alkane-selective membrane.

20. The integrated refining unit that performs the process of claim 1, comprising: the steam cracker; the normal alkane-selective membrane that is fluidly connected to the steam cracker; and a hydrocracker that has a first pipe, that receives the membrane reject stream from the normal alkane-selective membrane, and a second pipe that elutes a hydrocracked stream to the steam cracker.
